(19) United States
(12) Patent Application Publication
(10) Pub. No.: US 2021/0339761 A1
(43) Pub. Date: Nov. 4, 2021

(54) VEHICLE-MOUNTED CONTROL APPARATUS, VEHICLE, VEHICLE CONTROL METHOD, AND VEHICLE CONTROL SYSTEM

(71) Applicant: HONDA MOTOR CO., LTD., Tokyo (JP)

(72) Inventors: Yotaro MORI, Wako-shi (JP); Keisuke KISHIKAWA, Wako-shi (JP); Kohei NOGUCHI, Wako-shi (JP); Kenichi OHIRA, Tokyo (JP)

(21) Appl. No.: 17/378,261

(22) Filed: Jul. 16, 2021

Related U.S. Application Data
(63) Continuation of application No. PCT/JP2019/003532, filed on Jan. 31, 2019.

(51) Int. Cl. B60W 50/04; B60W 50/10; B62K 11/00

(52) U.S. Cl. CPC B60W 50/045; B60W 2050/0075; B62K 11/00; B60W 50/10

(57) ABSTRACT

A vehicle-mounted control apparatus comprises a controller configured to control the drive power source of the vehicle on the basis of the control signal, wherein the controller puts the drive power source into a startable state or an unstartable state in accordance with the control signal, monitors the control signal, and when a transmission source of the control signal is determined to have malfunctioned, puts the drive power source into the startable state regardless of the control signal.

### CROSS-REFERENCE TO RELATED APPLICATION(S)

This application is a continuation of International Patent Application No. PCT/JP2019/003532 filed on Jan. 31, 2019, the entire disclosures of which are incorporated herein by reference.

### TECHNICAL FIELD

The present invention relates to a vehicle-mounted control apparatus and a vehicle including the same, a vehicle control method, and a vehicle control system.

### BACKGROUND ART

A vehicle-mounted device that remotely changes a vehicle to an unstartable state in response to an instruction from a server when the vehicle has not been paid for, to prevent the vehicle from being stolen, and the like has been proposed (see PTL 1). PTL 1 describes selectively putting the vehicle into an unstartable state or a startable state when an anomaly such as a wire connected to the vehicle-mounted device being cut or disconnected is detected.

### CITATION LIST

### Patent Literature

PTL 1: Japanese Patent No. 6238038

### SUMMARY OF INVENTION

### Technical Problem

However, PTL 1 does not specify what to do in a situation where a communication apparatus for communicating with the server malfunctions.

Furthermore, if the vehicle has been put into an unstartable state remotely in response to an instruction from the server, the vehicle must be put back into a startable state by the server in order to move the vehicle, and if the vehicle has been put into an unstartable state in response to an anomaly being detected, it is necessary to fix the anomaly in question. In this case, even if there is an urgent need to use the vehicle, it may not be possible to use the vehicle at the appropriate time.

Having been achieved in light of the stated conventional example, an object of the present invention is to take appropriate measures even when a communication apparatus malfunctions. A further object is to maintain the availability of the vehicle.

### Solution to Problem

In order to achieve the above object, the present invention is configured as follows. That is, according to a first aspect, provided is a vehicle-mounted control apparatus, comprising: a controller configured to control a drive power source of a vehicle on the basis of a control signal that has been received, wherein the controller comprises at least one memory that stores at least one program, and at least one processor, the at least one program is configured to cause, when executed by the processor, the controller to: put the drive power source into a startable state or an unstartable state in accordance with the control signal, and monitor the control signal, and when a transmission source of the control signal is determined to have malfunctioned, put the drive power source into the startable state regardless of the control signal.

According to a second aspect, provided is a vehicle-mounted control apparatus, comprising: a controller configured to control a drive power source of a vehicle on the basis of a control signal that has been received, wherein the controller comprises at least one memory that stores at least one program, and at least one processor, the at least one program is configured to cause, when executed by the processor, the controller to: set the drive power source to a startable state or an unstartable state in accordance with the control signal, monitor the control signal, and when a transmission source of the control signal is determined to have malfunctioned, keep the drive power source in a state that was set last.

According to a third aspect, provided is a vehicle, comprising: a vehicle-mounted control apparatus; a drive power source controlled by the vehicle-mounted control apparatus; and a driving unit driven by the drive power source, wherein the vehicle-mounted control apparatus comprises: a controller configured to control a drive power source of a vehicle on the basis of a control signal that has been received, wherein the controller comprises at least one memory that stores at least one program, and at least one processor, the at least one program is configured to cause, when executed by the processor, the controller to: put the drive power source into a startable state or an unstartable state in accordance with the control signal, and monitor the control signal, and when a transmission source of the control signal is determined to have malfunctioned, put the drive power source into the startable state regardless of the control signal.

According to a fourth aspect, provided is a vehicle control system, comprising: a vehicle, the vehicle including a vehicle-mounted control apparatus, a drive power source controlled by the vehicle-mounted control apparatus, and a driving unit driven by the drive power source; and a server that sends the message to the communication unit, the message being based on an event that has occurred, wherein the vehicle-mounted control apparatus comprises: a controller configured to control a drive power source of a vehicle on the basis of a control signal that has been received; and a communication unit that is the transmission source of the control signal, the communication unit receiving a message from outside and periodically transmitting the control signal to the controller in response to the message, wherein the controller comprises at least one memory that stores at least one program, and at least one processor, the at least one program is configured to cause, when executed by the processor, the controller to: put the drive power source into a startable state or an unstartable state in accordance with the control signal, and monitor the control signal, and when a transmission source of the control signal is determined to have malfunctioned, put the drive power source into the startable state regardless of the control signal.

According to a fifth aspect, provided is a vehicle control system, comprising: a server that sends a message to a communication unit of a vehicle, the message being based on an event that has occurred; and a vehicle, wherein the vehicle includes: a communication unit that receives the message and sends, to a controller, a control signal based on the message that has been received; and a controller, wherein the controller comprises at least one memory that stores at least one program, and at least one processor, the at least one program is configured to cause, when executed by the processor, the controller to: set a drive power source of the vehicle to a startable state or an unstartable state in accordance with the control signal that has been received, monitor the control signal, and when the communication unit is determined to have malfunctioned, put the drive power source into the startable state regardless of the control signal.

According to a sixth aspect, provided is a vehicle control system, comprising: a server that sends the message to a communication unit of a vehicle, the message being based on an event that has occurred; and a vehicle, wherein the vehicle includes: a communication unit that receives the message and sends, to a controller, a control signal based on the message that has been received; and a controller, wherein the controller comprises at least one memory that stores at least one program, and at least one processor, the at least one program is configured to cause, when executed by the processor, the controller to: set a drive power source of the vehicle to a startable state or an unstartable state in accordance with the control signal that has been received, monitor the control signal, and when the communication unit is determined to have malfunctioned, keep the drive power source in a state that was set last.

### Advantageous Effects of Invention

According to the present invention, appropriate measures can be taken even when a communication apparatus malfunctions. The availability of a vehicle can be maintained as well.

### BRIEF DESCRIPTION OF DRAWINGS

FIG. 1 is a block diagram illustrating an example of a system formed among a vehicle, a user thereof, and a dealer.

FIG. 2 is a block diagram illustrating an example of a vehicle configuration which enables control of a drive power source.

FIG. 3 is a flowchart illustrating an example of control of a state of the drive power source by a control apparatus.

FIG. 4 is a flowchart illustrating an example of control of the drive power source by the control apparatus.

FIG. 5 is a state transition diagram illustrating states of control of the drive power source by the control apparatus.

FIG. 6 is a sequence chart illustrating overall operations of a system for a vehicle use service.

### DESCRIPTION OF EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

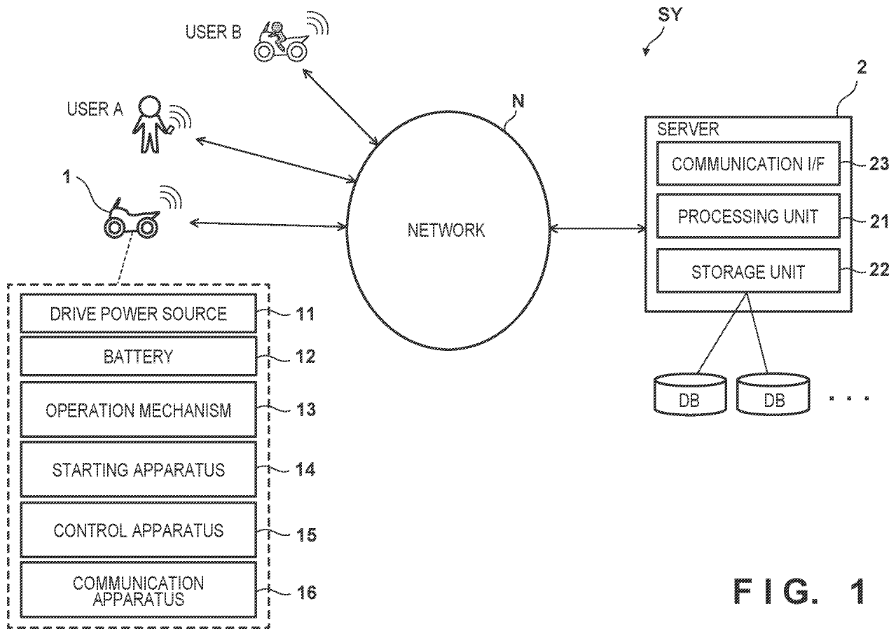

FIG. 1 illustrates an example of the configuration of a vehicle use service system SY according to a first embodiment. The system SY includes at least one vehicle 1, a user or users thereof (e.g., users A and B), and a server 2 of a management company which can communicate with the vehicle(s) 1 over a network N, and is also called a vehicle control system.

The vehicle 1 is a straddle-type vehicle in the present embodiment, but may be a passenger vehicle in another embodiment. Note that “straddle-type vehicle” refers to a vehicle which a driver rides by straddling a vehicle body, and is a concept which includes not only typical two-wheeled vehicles (including scooter-type vehicles), but also three-wheeled vehicles (vehicles having one front wheel and two rear wheels, or two front wheels and one rear wheel), all-terrain vehicles (ATVs) such as four-wheeled buggies, and so on.

The vehicle 1 includes a drive power source 11, a battery 12, an operation mechanism 13, a starting apparatus 14, a control apparatus 15, and a communication apparatus 16. Although the drive power source 11 is assumed to be an internal combustion engine (an engine) in the present embodiment, an electric motor, such as a three-phase induction motor or the like, may be used as the drive power source 11. A secondary battery which can be recharged based on power from the drive power source 11 is used as the battery 12, and a lead storage battery, a lithium-ion battery, a nickel hydride battery, and the like can be given as examples thereof.

The operation mechanism 13 is configured to be capable of making inputs for controlling the drive power source 11, and outputs predetermined control signals to the control apparatus 15, which will be described later, on the basis of operations input by the user A, for example. A rotation operation using a predetermined key corresponding to the vehicle 1 (an ignition key, a remote key, or the like), a pushing operation using a push-type switch (a start switch or the like), and so on can be given as examples of operation inputs made using the operation mechanism 13.

The starting apparatus 14 can start the drive power source 11 and put the drive power source 11 into a running state, and stop the drive power source 11 which is in the running state, on the basis of an operation input made using the operation mechanism 13. A publicly-known ignition device including an igniter or the like may be used as the starting apparatus 14.

Although details will be given later, the control apparatus 15 is an ECU (electronic control unit) capable of controlling the operations of the vehicle 1 as a whole, and is capable, for example, of exchanging signals with the various constituent elements of the vehicle 1 via predetermined signal lines. As one example, the control apparatus 15 can receive a control signal based on an operation input made through the aforementioned operation mechanism 13 and cause the starting apparatus 14 to start the drive power source 11.

The functions of the control apparatus 15 can be realized by hardware or software. For example, the functions of the control apparatus 15 may be realized by a central processing unit (CPU) executing predetermined programs using memory. Alternatively, the functions of the control apparatus 15 may be realized by a publicly-known semiconductor device such as a Programmable Logic Device (PLD), an Application-Specific Integrated Circuit (ASIC), or the like. Additionally, although the control apparatus 15 is indicated here as a single element, the control apparatus 15 may be divided into two or more elements as necessary. Additionally, in the present embodiment, the control apparatus 15 includes a programmable timer.

The communication apparatus 16 has an antenna for communicating with a network N, and includes a telematics control unit (TCU) that performs signal processing for communicating with the network N. From the perspective of the control apparatus 15, the control apparatus 15 can communicate with the server 2, which will be described later, over the network N using the communication apparatus 16. Note that some of the functions of the aforementioned TCU may be provided in the control apparatus 15, and some of the functions of the control apparatus 15 may be provided in the aforementioned TCU.

The server 2 includes a processing unit 21, a storage unit 22, and a communication interface unit 23, and can be installed, for example, in an office or the like of a management company that offers a vehicle use service. The processing unit 21 is assumed to be a processor including a CPU and memory, and the storage unit 22 is assumed to be a relatively large-capacity hard disk drive (HDD). These elements may be in a distributed form in the cloud.

For example, the processing unit 21 can communicate with the vehicle 1 over the network N using the communication interface unit 23, and can store information on the vehicle 1 in the storage unit 22, or read out such information from the storage unit 22. The processing unit 21 can also communicate with a terminal (a mobile terminal such as a smartphone) of the user A of the vehicle 1, and can store information on the user A in the storage unit 22, or read out such information from the storage unit 22. A database DB for the vehicle 1 and the user A thereof is formed by associating the information on the vehicle 1 and the information on the user A with each other. Databases DB are also formed for another user B who is driving, as well as other users not shown here.

In this vehicle use service system SY, the server 2 of the management company can communicate with the vehicle 1, the user A, and the like and perform predetermined management. A vehicle sales service, a vehicle rental service, and the like can be given as examples of the vehicle use service, and permitting or restricting the use of the vehicle 1 by a user can be given as an example of the management performed by the management company.

For example, when a vehicle has been sold according to a loan contract entered into between the management company and the user A, the server 2 of the management company can permit the user A to use the vehicle 1 while the user A is making proper payments, and can restrict the use when the user A fails to make a payment. As one example, the server 2 manages the state of payments by the user A in the database DB, and when there is an operation restriction event, such as failure to make a payment, sends a signal requesting the vehicle 1 to be put into an unusable state, e.g., a signal requesting the starting of the drive power source 11 to be restricted (also called an “operation restriction message”), to the vehicle 1 of the user A. In the vehicle 1, the control apparatus 15 can control the starting of the drive power source 11 by the starting apparatus 14 in response to the aforementioned signal from the server 2 being received by the communication apparatus 16. The server 2 may also send, to the vehicle 1 of the user A, a signal canceling the restriction on the starting of the drive power source 11 (an “operation permission message”) when there is an operation permission event such as, for example, a back payment being made.

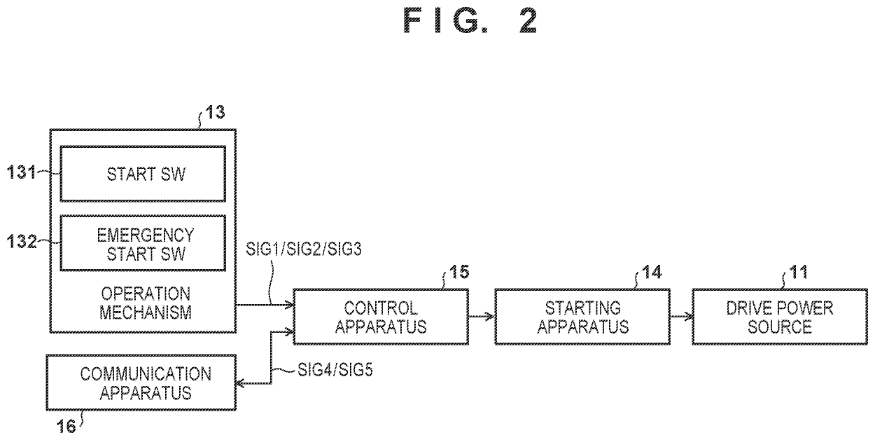

FIG. 2 illustrates an example of a configuration which makes it possible to control the drive power source 11 in the vehicle 1, according to the present embodiment. The control apparatus 15 receives signals from the operation mechanism 13 and the communication apparatus 16, and on the basis of the signal or signals, controls (starts/stops) the drive power source 11 through the starting apparatus 14.

The operation mechanism 13 can selectively output a start signal SIG1 and a stop signal SIG2 as the control signals for controlling the drive power source 11. The start signal SIG1 is a control signal for starting the drive power source 11 when the drive power source 11 is in a stopped state. The stop signal SIG2 is a control signal for stopping the drive power source 11 when the drive power source 11 is in a running state. For example, when an operation instructing the drive power source 11 to start has been input to the operation mechanism 13, the operation mechanism 13 outputs the start signal SIG1 to the control apparatus 15. Likewise, when an operation instructing the drive power source 11 to stop has been input to the operation mechanism 13, the operation mechanism 13 outputs the stop signal SIG2 to the control apparatus 15. Note that signals SIG1 to SIG3 are signals which convey an on or off state of a start switch 131 and an emergency start switch 132, and these signals may be transmitted by, for example, independent signal lines. On the other hand, signals SIG4 and SIG5 may have different signal values such that those signals can be identified, and need not be transmitted by independent signal lines.

The start switch 131 and the emergency start switch 132 are included in the operation mechanism 13. The start switch 131 is, for example, a switch, a button, or the like, such as an ignition key as mentioned earlier. The control apparatus 15 may enter an unstartable state, in which the drive power source 11 is not permitted to be started, as will be described later. The emergency start switch 132 is a switch for permitting starting even during the unstartable state, in exceptional cases such as emergency situations. Although the drive power source 11 may be configured to be startable using only the emergency start switch 132, in this example, the drive power source 11 enters an emergency startable state when an emergency start signal SIG3 is input to the control apparatus 15 while the emergency start switch 132 is on, and the drive power source 11 then starts when the start switch 131 is turned on while in this state. Note that the starting of the drive power source 11 using the emergency start switch 132 may be permitted only a predetermined number of times. The predetermined number of times may be one time, or a number exceeding one may be permitted. When the number of times an emergency start is permitted is one, the emergency start switch 132 may have a mechanical configuration that permits only a single operation. For example, the switch may be a pushbutton switch that, once pushed in, does not return and cannot easily be pulled back out. Of course, the configuration of the emergency start switch 132 is not limited thereto. Furthermore, the configuration may be such that the drive power source 11 is permitted to be used only a predetermined number of times, e.g., once, electrically or electronically instead of mechanically. Regardless of the type, in the present embodiment, once the emergency start switch 132 has been rendered unusable, it is necessary for the dealer of the vehicle 1, for example, to perform work to render the switch usable again before the switch can be used again.

The communication apparatus 16 (also called a “communication unit” or “TCU” hereinafter) can output a start restriction signal SIG4 as a control signal for controlling the drive power source 11. Although details will be given later, the start restriction signal SIG4 is a control signal for restricting the starting of the drive power source 11 based on the start signal SIG1. The start restriction signal SIG4 may be expressed as a disable signal, a deactivation signal, or the like, or in another embodiment, in which the logic levels of the signal are reversed, may be expressed as an enable signal, a start permission signal, or the like. The communication apparatus 16 may input a normal signal SIG5 to the control apparatus 15. The normal signal SIG5 is a signal for permitting the drive power source 11 to be started, and may be called an “enable signal”. Note that the start restriction signal SIG4 is output in response to the communication apparatus 16 receiving, from the server 2, a message indicating that the starting is to be restricted. Additionally, the communication apparatus 16 may send the deactivation signal SIG4 or the normal signal SIG5 to the control apparatus 15, for example periodically, in order to indicate that the communication apparatus 16 is connected to the control apparatus 15 and is functioning normally. Alternatively, the communication apparatus 16 may be configured to return the normal signal SIG5 or the deactivation signal SIG4 in response to an inquiry from the control apparatus 15. By doing so, the communication apparatus 16 and the control apparatus 15 can monitor whether the other is operating normally.

The control apparatus 15 controls the drive power source 11 on the basis of the above-described signals SIG1 to SIG5. For example, before receiving the start restriction signal (the deactivation signal) SIG4, the control apparatus 15 starts the drive power source 11 in response to receiving the start signal SIG1 and stops the drive power source 11 in response to receiving the stop signal SIG2. Additionally, after receiving the start restriction signal SIG3, the control apparatus 15 does not start the drive power source 11 even if the start signal SIG1 has been received. Additionally, although details will be given later, when the drive power source 11 has entered the running state, the control apparatus 15 does not stop the drive power source 11 in the running state even if the start restriction signal SIG4 is received, and keeps the drive power source 11 in the running state until the stop signal SIG2 is received.

### Control by Vehicle Use Service System

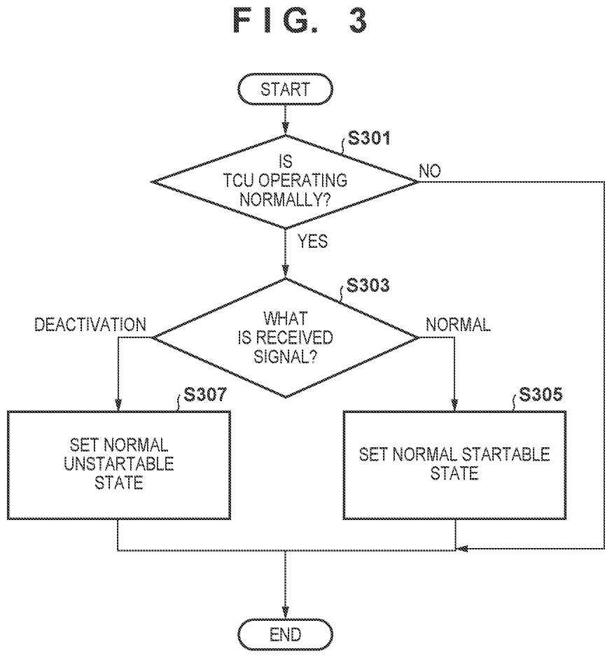

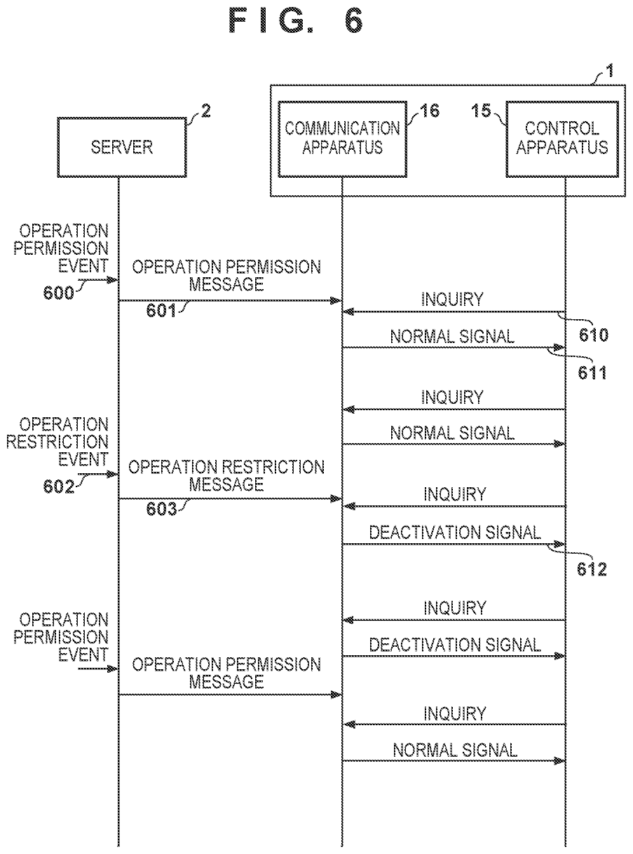

FIG. 6 illustrates an overview of a control sequence performed by the vehicle use service system SY. When, for example, a user purchases the vehicle 1 and the dealer generates an operation permission event 600 permitting the use of the vehicle 1, the server 2 sends an operation permission message 601 to the vehicle 1, and to the communication apparatus 16 in particular, for which operation is to be permitted. The operation permission event 600 is, for example, operation permission being input by an administrator of the server 2, and the operation permission is input when, for example, the buyer makes the first payment or pays the full amount. The communication apparatus 16 of the vehicle 1 that has received the operation permission message 601 stores the fact that the operation permission message 601 has been received. The control apparatus 15 periodically sends an inquiry signal 610 to the communication apparatus 16. Having received that signal, the communication apparatus 16 returns a normal signal 611 to the control apparatus 15 as long as an operation restriction message 603 is not received. This is because the normal signal 611 also serves as a message through which the control apparatus 15 confirms that the communication apparatus 16 is operational. Having received the normal signal from the communication apparatus 16, the control apparatus 15 sets a state indicating that the drive power source 11 can be started by executing the processing illustrated in FIG. 3, which will be described later. Note that in addition to a command state indicating one of the normal signal or the deactivation signal, a response value indicating the state of the communication apparatus 16 is included in the response signal from the communication apparatus 16. The response value is a value indicating the state of the communication apparatus 16, for example. For example, the communication apparatus 16 may include a self-diagnostic circuit, and for example, a code indicating the result of a diagnosis executed by the self-diagnostic circuit when the power of the vehicle 1 is turned on or the like may be used as the response value.

If, for example, the buyer is behind on their payments, an operation restriction event 602 occurs, and in response thereto, the server 2 sends the operation restriction message 603 to the communication apparatus 16 of the vehicle 1 in question. The operation restriction event 602 is, for example, the administrator of the server 2 inputting an operation restriction. The communication apparatus 16 of the vehicle 1 that has received the operation restriction message 603 stores the fact that the operation restriction message 603 has been received. The control apparatus 15 periodically sends the inquiry signal 610 to the communication apparatus 16. Having received the signal, the communication apparatus 16 returns a deactivation signal 612 to the control apparatus 15 until the operation permission message 601 is received again. Having received the deactivation signal from the communication apparatus 16, the control apparatus 15 sets a state indicating that the drive power source 11 cannot be started by executing the processing illustrated in FIG. 3, which will be described later.

In the present embodiment, when an operation permission event occurs again after an operation restriction event has occurred, the server 2 sends the operation permission message 601 to the vehicle 1, and to the communication apparatus 16 in particular, for which the operation is to be permitted. Then, as mentioned in the beginning of the descriptions of FIG. 6, the normal signal 611 is sent from the communication apparatus 16 to the control apparatus 15 in response to the periodic inquiry 610 from the control apparatus 15, and the vehicle 1 can then be used.

### Processing of Signals from Communication Apparatus 16 by Control Apparatus (Also Called “Control Unit”)

FIG. 3 is a flowchart illustrating an example of a sequence, performed by the control apparatus 15, for processing a signal received from the communication apparatus 16 response to an inquiry from the control apparatus 15. The sequence is executed when the control apparatus 15 receives a signal from the communication apparatus 16.

First, it is determined whether the communication apparatus 16 (TCU) is operating normally (S301). Whether or not the communication apparatus 16 is operating normally can be determined on the basis of the response value included in the received signal. It is determined that the communication apparatus 16 is not operating normally when the response value included in the received signal indicates an anomaly in the communication apparatus 16. Additionally, providing error correction code in the respective signal values makes it possible to correct signal errors, to a certain extent, in the communication channel, rather than in the communication apparatus 16 itself, and this in turn makes it possible to increase the accuracy of the determination that the communication apparatus 16 is not operating normally. If there is an anomaly in the communication apparatus 16, but the anomaly does not interfere with communication, the communication apparatus 16 is determined to be operating normally.

When it is determined in step S301 that the communication apparatus 16 is operating normally, it is determined whether the received signal is a deactivation signal or a normal signal (S303). A normal unstartable state is set if the signal is determined to be a deactivation signal (S307), whereas a normal startable state is set if the signal is determined to be a normal signal (S305). “Normal start” refers to a starting method which uses the start switch 131 but does not use the emergency start switch 132. The normal unstartable state and the normal startable state may be variables indicating states stored in non-volatile memory or the like of the control apparatus 15, for example, and those states are set by setting those state variables to values indicating the unstartable state and the startable state, respectively. It is not necessary to repeatedly set the same state, and thus it may be determined whether or not the current state is the same as the state which is to be set, with the setting of the state being skipped when the state is the same. Note that the normal unstartable state and the normal startable state may be called the “unstartable state” and the “startable state”, respectively.

Note that if it is determined in step S301 that the communication apparatus 16 is not operating normally, the processing ends. In other words, if the communication apparatus 16 is not operating normally, the state effective immediately before is maintained. For example, if the state immediately before is the startable state, the startable state is maintained during the period in which the communication apparatus 16 is not operating normally, whereas if the state immediately before is the unstartable state, the unstartable state is maintained during the period in which the communication apparatus 16 is not operating normally. Note that even if the communication between the communication apparatus 16 and the control apparatus 15 is cut off due to the communication apparatus 16 being removed, a communication line from the communication apparatus 16 being cut, or the like, no particular action is taken in this example, and thus the state immediately before (this can also be called the “latest state” or the “last state”) is maintained.

### Processing for Starting Drive Power Source

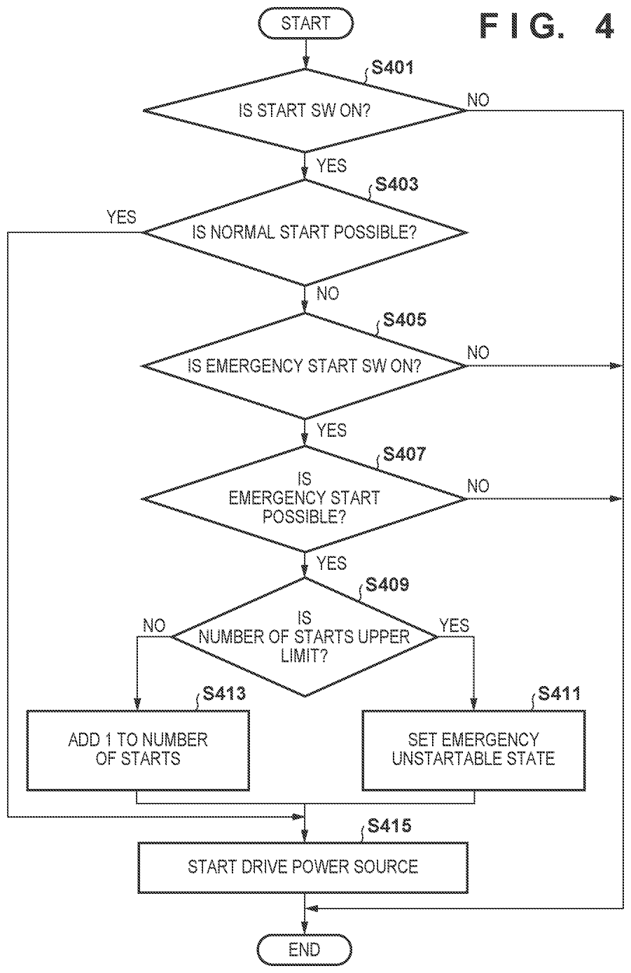

FIG. 4 illustrates a processing sequence performed by the control apparatus 15 when the start switch 131 is turned on. First, it is determined whether the start switch 131 is on (S401). Here, the sequence illustrated in FIG. 4 may be started in response to the start switch 131 turning on, and in this case, the sequence starts from step S403, without step S401 being executed. Next, it is determined whether the current state of the control apparatus 15 is the startable state (S403). If the state is the startable state, the sequence branches to step S415, and the drive power source 11 is started using the starting apparatus 14. Note that the start switch 131 can be determined to be on the basis of the start signal SIG1 being input.

On the other hand, if the state is not the startable state, i.e., is the unstartable state, it is determined whether the emergency start switch 132 is on (S405). The emergency start switch 132 can be determined to be on the basis of the emergency start signal SIG3 being received. If the emergency start switch 132 is on, it is determined whether an emergency start is possible for an emergency start state (S407). Like a normal start state indicating a startable or unstartable state, the emergency start state may be indicated by a state variable held in memory within the control apparatus 15. If it is determined in step S407 that an emergency start is possible for the emergency start state, it is determined whether the number of emergency starts has reached an upper limit thereof (S409). Here, the upper limit number may be 1, for example. If the upper limit has been reached, an emergency unstartable state is set as the emergency start state (S411). On the other hand, if the number of emergency starts has not reached the upper limit, 1 is added to the number of emergency starts (S413). The number of emergency starts is also stored in the non-volatile memory of the control apparatus 15. The default value thereof is 0, for example, and the number of emergency starts is counted on the basis of that default value. The drive power source 11 is then started (S415).

Through the sequence in FIG. 4, when the start switch 131 is turned on, the drive power source 11 is started if the state is the startable state. Furthermore, if the emergency start switch is on, the drive power source 11 can be started even if the state is the unstartable state, as long as the number of emergency starts is within a predetermined number. Additionally, if the communication apparatus 16 has malfunctioned, communication with the communication apparatus 16 has been cut off, or the like, the last starting state is held. As such, if the last state is the startable state, the drive power source 11 can be started even if the communication apparatus 16 has malfunctioned, communication has been cut off, or the like. Conversely, if the last state is the unstartable state, the drive power source 11 cannot be started even if the communication apparatus 16 has malfunctioned, communication has been cut off, or the like. Note that the communication being cut off can be detected by, for example, the communication apparatus 16 periodically sending a signal to the control apparatus 15, and the control unit 15 monitoring whether the signal is being periodically sent using a timer, for example.

### Normal Start State/Emergency Start State Transitions

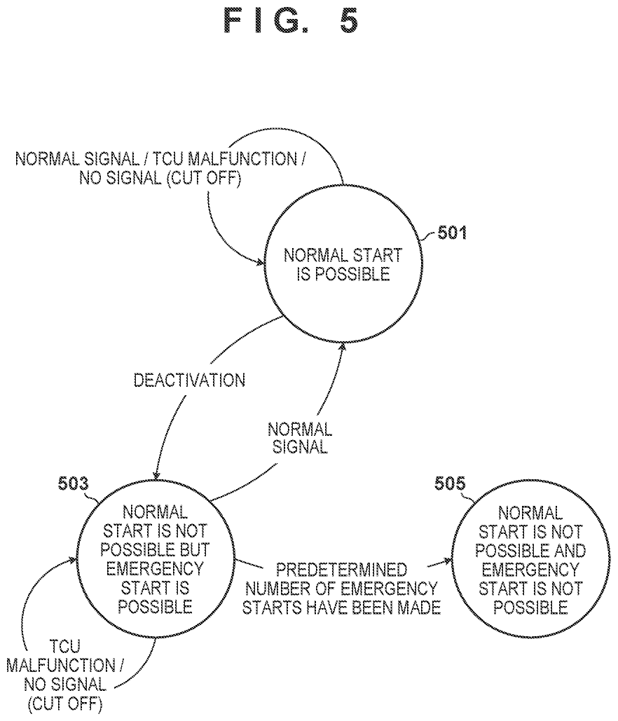

FIG. 5 illustrates transitions of the start state and the emergency start state according to the present embodiment. As long as the units are functioning normally and the message putting the start state into the unstartable state is not received from the server 2, the start state and the emergency start state are a state 501 in which normal starting as possible. In the state 501, the drive power source 11 is permitted to be started normally, but turning the emergency start switch 132 on and performing an emergency start is not permitted. The state 501 is maintained even if a normal signal is received from the communication apparatus 16, it is determined that the communication apparatus 16 has malfunctioned, or the connection with the communication apparatus 16 has been lost (no signal, or communication has been cut off). Accordingly, the drive power source 11 can be started normally regardless of the state of the communication apparatus 16. The state changes when a deactivation signal is received from the communication apparatus 16, and in this case, the state transitions to a state 503, in which the drive power source 11 cannot be started normally and an emergency start is possible.

In the state 503, normal starting of the drive power source 11, in which the emergency start switch 132 is not used, is not permitted, but emergency starting, in which the emergency start switch 132 is turned on to start the drive power source 11, is permitted. The state 503 is maintained even if a normal signal is received from the communication apparatus 16, it is determined that the communication apparatus 16 has malfunctioned, or the connection with the communication apparatus 16 has been lost (no signal, or communication has been cut off). Accordingly, the drive power source 11 cannot be started, but emergency starting is possible, regardless of the state of the communication apparatus 16. The state changes when a normal signal is again received from the communication apparatus 16, and in this case, the state transitions to the state 501, in which the drive power source 11 can be started normally. At this time, the number of emergency starts is returned to 0. However, if the number of permitted emergency starts is assigned for the entire period over which the vehicle 1 is used, the number may be totaled, without returning the number of emergency starts to 0, even when the state changes. Additionally, the state changes even when a predetermined number of emergency starts (e.g., one) have been made in the state 503, and in this case, the state transitions to a state 505.

In the state 505, the drive power source 11 cannot be started. Neither normal starting nor emergency starting is permitted. Additionally, in the present embodiment, once the state has transitioned to the state 505, the state cannot be returned to the state 501 without service from a dealership or the like. At the dealership or the like, the start state and the emergency start state are overwritten to return to the state 501 by, for example, a user inputting a confidential signal to the control apparatus 15. Furthermore, if the emergency start switch 132 has a mechanism which allows only a single use, replacing the emergency start switch 132 can also be used as a condition for returning the state to the state 501. In this case, a sensor that monitors the current state of the emergency start switch 132 (whether used or unused) may be provided, and the emergency start switch 132 being unused may be included as one condition for returning the state to the state 501.

According to the vehicle of the present embodiment as described thus far, by not permitting the drive power source to be started in accordance with a signal from the server, the use of the vehicle can be stopped in situations where, for example, the buyer of the vehicle does not make a payment, the vehicle has been stolen, and the like. Furthermore, even if the communication apparatus has malfunctioned, the state from before the malfunction can be maintained. Furthermore, even if signals from the communication apparatus have been cut off, the state from before the cutoff can be maintained. Furthermore, even in a state where starting is not permitted due to the signal from the server, providing the emergency start switch separately makes it possible to start the drive power source, and use the vehicle, only a predetermined number of times, for emergency situations. Furthermore, limiting the number of times an emergency start is permitted to a predetermined number makes it possible to prevent departures from the intent of not permitting the vehicle to be used.

### Other Embodiments

In the foregoing embodiment, for example, in the state 501, the drive power source can be started normally, as indicated in FIG. 5; however, no particular restrictions are placed on emergency starts. This is because if the drive power source can be started normally, there is no need to perform an emergency start, and if an emergency start is performed, the permitted number of emergency starts will be wasted; it is therefore thought that no users will perform an emergency start. However, the emergency start may be disabled in the state 501. In this case, for example, when the state is determined to be the startable state in step S403 of FIG. 4, the state of the emergency start switch 132 may be determined, and if the switch is on, the processing may end directly and the drive power source 11 may be started.

Furthermore, as described with reference to FIG. 5, in the foregoing embodiment, the state transitions to the state 501, in which a normal start is possible, when a normal signal is received from the communication apparatus 16 in the state 503, in which a normal start is not possible but an emergency start is possible. The configuration may be such that in the state 503, the state does not change even if the normal signal is received, but transitions to the state 501 when an activation signal, provided separately, is received from the communication apparatus 16.

Furthermore, as described with reference to FIG. 5, in the foregoing embodiment, the state transitions to the state 501, in which a normal start is possible, when a normal signal is received from the communication apparatus 16 in the state 503, in which a normal start is not possible but an emergency start is possible. The configuration may be such that like the state 505, in the state 503, the state does not return to the state 501 depending on the signal received, but returns to the state 501 through service performed by a dealership or the like, for example.

Furthermore, as described with reference to FIG. 5, in the foregoing embodiment, the state can only be returned to the state 501 from the state 505 through service performed by a dealership or the like. As opposed to this, the configuration may be such that a specific restoration signal is sent from the server 2 to the communication apparatus 16, and the state is returned from the state 505 to the state 501 when the control apparatus 15 receives the restoration signal from the communication apparatus 16. However, if the emergency start switch 132 has a mechanism that allows for only a single use, and the emergency start switch 132 has already been used, it is necessary to replace that switch separately.

Furthermore, when the communication apparatus 16 has malfunctioned, the last state is maintained, depending on the start state, but the state may be changed to the startable state. This may be the same when communication from the communication apparatus 16 has been cut off. Additionally, although the foregoing embodiment describes turning the start switch 131 on after turning the emergency start switch 132 on when performing an emergency start, the configuration may be such that an emergency start can be performed simply by turning the emergency start switch 132 on.

Furthermore, although the foregoing embodiment describes a straddle-type vehicle 1 as a typical example, the details of the embodiments can not only be applied to a wide variety of vehicles, but also to items lacking wheels (e.g., ships and the like). In other words, the details of the embodiments can be applied to a wide variety of moving bodies.

### Summary of Embodiments

According to a first embodiment of the present invention, a vehicle-mounted control apparatus is provided, the vehicle-mounted control apparatus characterized by including control means (15) for controlling a drive power source (11) of a vehicle on the basis of a control signal that has been received. The control means (15) puts the drive power source (11) into a startable state or an unstartable state in accordance with the control signal, monitors the control signal, and when a transmission source of the control signal is determined to have malfunctioned, puts the drive power source (11) into the startable state regardless of the control signal.

According to this configuration, even if the drive power source has been put into the unstartable state by the control signal, the drive power source can be started upon entering a state in which the control signal is not received.

According to a second embodiment of the present invention, a vehicle-mounted control apparatus is provided, the vehicle-mounted control apparatus characterized by including control means (15) for controlling a drive power source (11) of a vehicle on the basis of a control signal that has been received. The control means (15) sets the drive power source (11) to a startable state or an unstartable state in accordance with the control signal, monitors the control signal, and when a transmission source of the control signal is determined to have malfunctioned, keeps the drive power source in a state that was set last.

According to this configuration, when the transmission source of the control signal has malfunctioned, the drive power source can be kept in the same state, regardless of whether that state is the unstartable state or the startable state.

According to a third embodiment of the present invention, the vehicle-mounted control apparatus according to the first or second embodiment is provided, the vehicle-mounted control apparatus characterized in that the control means can start the drive power source up to a predetermined number of times even when the drive power source is in the unstartable state in response to the control signal.

According to this configuration, the vehicle can be used a predetermined number of times even if the drive power source is in the unstartable state.

According to a fourth embodiment of the present invention, the vehicle-mounted control apparatus according to the third embodiment is provided, the vehicle-mounted control apparatus characterized by further including operation means capable of a starting operation of the drive power source up to the predetermined number of times when the drive power source is in the unstartable state in response to the control signal. When the starting operation has been performed by the operation means, the control means starts the drive power source even when the drive power source is in the unstartable state in response to the control signal.

According to this configuration, providing a dedicated operation means for using the drive power source even when the drive power source is in the unstartable state can improve the convenience.

According to a fifth embodiment of the present invention, the vehicle-mounted control apparatus according to the third or fourth embodiments is provided, the vehicle-mounted control apparatus characterized in that the predetermined number of times is one time in a single period in which the drive power source has entered the unstartable state.

According to this configuration, emergency starting can be used each time the vehicle enters the unstartable state, which improves the convenience.

According to a sixth embodiment of the present invention, the vehicle-mounted control apparatus according to the third or fourth embodiments is provided, the vehicle-mounted control apparatus characterized in that the predetermined number of times is one time for the vehicle.

According to this configuration, when the drive power source is in the unstartable state, the number of times an emergency start can be performed for the vehicle can be restricted, which makes it possible to prevent departures from the intent of the restriction.

According to a seventh embodiment of the present invention, the vehicle-mounted control apparatus according to the first to sixth embodiments is provided, the vehicle-mounted control apparatus characterized by further including a communication unit that is the transmission source of the control signal, the communication unit receiving a message from outside and periodically transmitting the control signal to the control unit in response to the message.

According to this configuration, control for handling malfunctions in the communication unit of the vehicle control apparatus can be performed.

According to an eighth embodiment of the present invention, a vehicle is provided, characterized by including: the vehicle-mounted control apparatus according to the first to seventh embodiments; a drive power source controlled by the vehicle-mounted control apparatus; and a driving unit driven by the drive power source.

According to this configuration, the effects of the vehicle-mounted control apparatus according to the first to seventh embodiments can be applied to a vehicle.

According to a ninth embodiment of the present invention, the vehicle according to the eighth embodiment is provided, the vehicle characterized in that the vehicle is a straddle-type vehicle.

According to this configuration, the effects of the vehicle-mounted control apparatus according to the first to sixth embodiments can be applied to a straddle-type vehicle.

According to a tenth embodiment of the present invention, a vehicle control system is provided, characterized by including: the vehicle according to the eighth or ninth embodiment; and a server that sends the message to the communication unit, the message being based on an event that has occurred.

According to this configuration, whether or not to permit the vehicle to operate can be controlled by a message from the server.

According to an eleventh embodiment of the present invention, a vehicle control method is provided, the vehicle control method characterized by including: a control unit of a vehicle receiving a control signal; and the control unit setting a drive power source of the vehicle to a startable state or an unstartable state in accordance with the control signal that has been received, monitoring the control signal, and when a transmission source of the control signal is determined to have malfunctioned, keeping the drive power source in a state that was set last.

According to this configuration, when the transmission source of the control signal has malfunctioned, the drive power source of the vehicle can be kept in the same state, regardless of whether that state is the unstartable state or the startable state.

According to a twelfth embodiment of the present invention, a vehicle control method is provided, the vehicle control method characterized by including: a control unit of a vehicle receiving a control signal; and the control unit setting a drive power source of the vehicle to a startable state or an unstartable state in accordance with the control signal that has been received, monitoring the control signal, and when a transmission source of the control signal is determined to have malfunctioned, putting the drive power source into the startable state regardless of the control signal.

According to this configuration, even if the drive power source of the vehicle has been put into the unstartable state by the control signal, the drive power source can be started upon entering a state in which the control signal is not received.

According to a thirteenth embodiment of the present invention, the vehicle control method according to the eleventh or the twelfth embodiment is provided, the vehicle control method characterized in that the control unit can start the drive power source up to a predetermined number of times even when the drive power source is in the unstartable state in response to the control signal.

According to this configuration, the vehicle can be used a predetermined number of times even if the drive power source is in the unstartable state.

According to a fourteenth embodiment of the present invention, the vehicle control method according to the thirteenth embodiment is provided, the vehicle control method characterized in that when, while the drive power source is in the unstartable state due to the control signal, a starting operation of the drive power source is performed by an operation unit capable of the starting operation up to the predetermined number of times, the control unit starts the drive power source even when the drive power source is in the unstartable state due to the control signal.

According to this configuration, providing a dedicated operation unit for using the drive power source even when the drive power source is in the unstartable state can improve the convenience.

According to a fifteenth embodiment of the present invention, the vehicle control method according to the thirteenth or fourteenth embodiment is provided, the vehicle control method characterized in that the predetermined number of times is one time in a single period in which the drive power source has entered the unstartable state.

According to this configuration, emergency starting can be used each time the vehicle enters the unstartable state, which improves the convenience.

According to a sixteenth embodiment of the present invention, the vehicle control method according to the thirteenth or fourteenth embodiment is provided, the vehicle control method characterized in that the predetermined number of times is one time for the vehicle.

According to this configuration, when the drive power source is in the unstartable state, the number of times an emergency start can be performed for the vehicle can be restricted, which makes it possible to prevent departures from the intent of the restriction.

According to a seventeenth embodiment of the present invention, the vehicle control method according to the eleventh to the sixteenth embodiment is provided, the vehicle control method characterized by further including the communication unit receiving a message from outside and periodically transmitting the control signal to the control unit in response to the message.

According to this configuration, control for handling malfunctions in the communication unit can be performed.

According to an eighteenth embodiment of the present invention, a vehicle control system is provided, the vehicle control system characterized by including a server and a vehicle. The server sends the message to a communication unit of a vehicle, the message being based on an event that has occurred. The vehicle includes: a communication unit that receives the message and sends, to a control unit, a control signal based on the message that has been received; and a control unit that sets a drive power source of the vehicle to a startable state or an unstartable state in accordance with the control signal that has been received, monitors the control signal, and when the communication unit is determined to have malfunctioned, keeps the drive power source in a state that was set last.

According to this configuration, when the communication unit has malfunctioned, the drive power source of the vehicle can be kept in the same state, regardless of whether that state is the unstartable state or the startable state.

According to a nineteenth embodiment of the present invention, a vehicle control system is provided, the vehicle control system characterized by including a server and a vehicle. The server sends the message to a communication unit of a vehicle, the message being based on an event that has occurred. The vehicle includes: a communication unit that receives the message and sends, to a control unit, a control signal based on the message that has been received; and a control unit that sets a drive power source of the vehicle to a startable state or an unstartable state in accordance with the control signal that has been received, monitors the control signal, and when the communication unit is determined to have malfunctioned, puts the drive power source into the startable state regardless of the control signal.

According to this configuration, when the communication unit has malfunctioned, the drive power source of the vehicle can be kept in the same state, regardless of whether that state is the unstartable state or the startable state.

According to a twentieth embodiment of the present invention, the vehicle control system according to the eighteenth or the nineteenth embodiment is provided, the vehicle control system characterized in that the control unit can start the drive power source up to a predetermined number of times even when the drive power source is in the unstartable state in response to the control signal.

According to this configuration, the vehicle can be used a predetermined number of times even if the drive power source is in the unstartable state.

According to a twenty-first embodiment of the present invention, the vehicle control system according to the twentieth embodiment is provided, the vehicle control system characterized in that when, while the drive power source is in the unstartable state due to the control signal, a starting operation of the drive power source is performed by an operation unit capable of the starting operation up to the predetermined number of times, the control unit starts the drive power source even when the drive power source is in the unstartable state due to the control signal.

According to this configuration, providing a dedicated operation unit for using the drive power source even when the drive power source is in the unstartable state can improve the convenience.

According to a twenty-second embodiment of the present invention, the vehicle control system according to the twentieth or twenty-first embodiment is provided, the vehicle control system characterized in that the predetermined number of times is one time in a single period in which the drive power source has entered the unstartable state.

According to this configuration, emergency starting can be used each time the vehicle enters the unstartable state, which improves the convenience.

According to a twenty-third embodiment of the present invention, the vehicle control system according to the twentieth or twenty-first embodiment is provided, the vehicle control system characterized in that the predetermined number of times is one time for the vehicle.

According to this configuration, when the drive power source is in the unstartable state, the number of times an emergency start can be performed for the vehicle can be restricted, which makes it possible to prevent departures from the intent of the restriction.

According to a twenty-fourth embodiment of the present invention, the vehicle control system according to the eighteenth to the twenty-third embodiment is provided, the vehicle control system characterized in that the communication unit periodically sends the control signal to the control unit in response to the message received from the server.

According to this configuration, control for handling malfunctions in the communication unit can be performed.

According to a twenty-fifth embodiment of the present invention, the vehicle control system according to the eighteenth to the twenty-fourth embodiments is provided, the vehicle control system characterized in that the vehicle is a straddle-type vehicle.

According to this configuration, the effects of the vehicle control system according to the eighteenth to twenty-fourth embodiments can be applied to a straddle-type vehicle.

The invention is not limited to the foregoing embodiments, and various variations/changes are possible within the spirit of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A vehicle-mounted control apparatus, comprising:
a controller configured to control a drive power source of a vehicle on the basis of a control signal that has been received,
wherein the controller comprises
at least one memory that stores at least one program, and
at least one processor,
the at least one program is configured to cause, when executed by the processor, the controller to:
put the drive power source into a startable state or an unstartable state in accordance with the control signal, and
monitor the control signal, and when a transmission source of the control signal is determined to have malfunctioned, put the drive power source into the startable state regardless of the control signal.

2. A vehicle-mounted control apparatus, comprising:
a controller configured to control a drive power source of a vehicle on the basis of a control signal that has been received,
wherein the controller comprises
at least one memory that stores at least one program, and
at least one processor,
the at least one program is configured to cause, when executed by the processor, the controller to:
set the drive power source to a startable state or an unstartable state in accordance with the control signal,
monitor the control signal, and when a transmission source of the control signal is determined to have malfunctioned, keep the drive power source in a state that was set last.

3. The vehicle-mounted control apparatus according to claim 1, wherein
the controller is configured to be able to start the drive power source up to a predetermined number of times even when the drive power source is in the unstartable state in response to the control signal.

4. The vehicle-mounted control apparatus according to claim 3, further comprising:
an operation unit capable of a starting operation of the drive power source up to the predetermined number of times when the drive power source is in the unstartable state in response to the control signal,
wherein when the starting operation has been performed by the operation unit, the control unit starts the drive power source even when the drive power source is in the unstartable state in response to the control signal.

5. The vehicle-mounted control apparatus according to claim 3, wherein
the predetermined number of times is one time in a single period in which the drive power source has entered the unstartable state.

6. The vehicle-mounted control apparatus according to claim 3, characterized in that
the predetermined number of times is one time for the vehicle.

7. The vehicle-mounted control apparatus according to claim 1, further comprising:
a communication unit that is the transmission source of the control signal, the communication unit receiving a message from outside and periodically transmitting the control signal to the control means in response to the message.

8. A vehicle, comprising:
a vehicle-mounted control apparatus;
a drive power source controlled by the vehicle-mounted control apparatus; and
a driving unit driven by the drive power source,
wherein the vehicle-mounted control apparatus comprises:
a controller configured to control a drive power source of a vehicle on the basis of a control signal that has been received,
wherein the controller comprises
at least one memory that stores at least one program, and
at least one processor,
the at least one program is configured to cause, when executed by the processor, the controller to:
put the drive power source into a startable state or an unstartable state in accordance with the control signal, and
monitor the control signal, and when a transmission source of the control signal is determined to have malfunctioned, put the drive power source into the startable state regardless of the control signal.

9. The vehicle according to claim 8, wherein
the vehicle is a straddle-type vehicle.

10. A vehicle control system, comprising:
a vehicle, the vehicle including a vehicle-mounted control apparatus, a drive power source controlled by the vehicle-mounted control apparatus, and a driving unit driven by the drive power source; and
a server that sends the message to the communication unit, the message being based on an event that has occurred,
wherein the vehicle-mounted control apparatus comprises:
a controller configured to control a drive power source of a vehicle on the basis of a control signal that has been received; and
a communication unit that is the transmission source of the control signal, the communication unit receiving a message from outside and periodically transmitting the control signal to the control means in response to the message,
wherein the controller comprises
at least one memory that stores at least one program, and
at least one processor,
the at least one program is configured to cause, when executed by the processor, the controller to:
put the drive power source into a startable state or an unstartable state in accordance with the control signal, and monitor the control signal, and when a transmission source of the control signal is determined to have malfunctioned, put the drive power source into the startable state regardless of the control signal.

11. A vehicle control method, comprising:
a server sending a message to a communication unit of a vehicle, the message being based on an event that has occurred;
a communication unit of the vehicle receiving the message and sending, to a control unit, a control signal based on the message that has been received; and
the control unit setting a drive power source of the vehicle to a startable state or an unstartable state in accordance with the control signal that has been received, monitoring the control signal, and when the communication unit is determined to have malfunctioned, putting the drive power source into the startable state regardless of the control signal.

12. A vehicle control method, comprising:
a server sending a message to a communication unit of a vehicle, the message being based on an event that has occurred;
a communication unit of the vehicle receiving the message and sending, to a control unit, a control signal based on the message that has been received; and
the control unit setting a drive power source of the vehicle to a startable state or an unstartable state in accordance with the control signal that has been received, monitoring the control signal, and when the communication unit is determined to have malfunctioned, keeping the drive power source in a state that was set last.

13. The vehicle control method according to claim 11, characterized in that
the control unit can start the drive power source up to a predetermined number of times even when the drive power source is in the unstartable state in response to the control signal.

14. The vehicle control method according to claim 13, characterized in that
when, while the drive power source is in the unstartable state due to the control signal, a starting operation of the drive power source is performed by an operation unit capable of the starting operation up to the predetermined number of times, the control unit starts the drive power source even when the drive power source is in the unstartable state due to the control signal.

15. The vehicle control method according to claim 13, characterized in that
the predetermined number of times is one time in a single period in which the drive power source has entered the unstartable state.

16. The vehicle control method according to claim 13, characterized in that
the predetermined number of times is one time for the vehicle.

17. The vehicle control method according to claim 11, further comprising:
the communication unit receiving a message from outside and periodically transmitting the control signal to the control unit in response to the message.

18. A vehicle control system, comprising:
a server that sends a message to a communication unit of a vehicle, the message being based on an event that has occurred; and
a vehicle,
wherein the vehicle includes:
a communication unit that receives the message and sends, to a controller, a control signal based on the message that has been received; and
a controller,
wherein the controller comprises
at least one memory that stores at least one program, and
at least one processor, the at least one program is configured to cause, when executed by the processor, the controller to:
set a drive power source of the vehicle to a startable state or an unstartable state in accordance with the control signal that has been received,
monitor the control signal, and when the communication unit is determined to have malfunctioned, put the drive power source into the startable state regardless of the control signal.

19. A vehicle control system, comprising:
a server that sends the message to a communication unit of a vehicle, the message being based on an event that has occurred; and
a vehicle,
wherein the vehicle includes:
a communication unit that receives the message and sends, to a controller, a control signal based on the message that has been received; and
a controller,
wherein the controller comprises
at least one memory that stores at least one program, and
at least one processor, the at least one program is configured to cause, when executed by the processor, the controller to:
set a drive power source of the vehicle to a startable state or an unstartable state in accordance with the control signal that has been received,
monitor the control signal, and when the communication unit is determined to have malfunctioned, keep the drive power source in a state that was set last.

20. The vehicle control system according to claim 18, wherein
the controller can start the drive power source up to a predetermined number of times even when the drive power source is in the unstartable state in response to the control signal.

21. The vehicle control system according to claim 20, wherein
when, while the drive power source is in the unstartable state due to the control signal, a starting operation of the drive power source is performed by an operation unit capable of the starting operation up to the predetermined number of times, the controller starts the drive power source even when the drive power source is in the unstartable state due to the control signal.

22. The vehicle control system according to claim 20, wherein
the predetermined number of times is one time in a single period in which the drive power source has entered the unstartable state.

23. The vehicle control system according to claim 20, wherein
the predetermined number of times is one time for the vehicle.

24. The vehicle control system according to claim 18, wherein
the communication unit periodically sends the control signal to the controller in response to the message received from the server.

25. The vehicle control system according to claim 18, wherein
the vehicle is a straddle-type vehicle.
